(19) United States
(12) Patent Application Publication
(10) Pub. No.: US 2022/0129934 A1
(43) Pub. Date: Apr. 28, 2022

(54) SYSTEM AND METHOD TO IDENTIFY AND REPRICE GOODS FOR RETAIL PRODUCT LOSS MINIMIZATION

(71) Applicant: Toshiba TEC Kabushiki Kaisha, Shinagawa-ku (JP)

(72) Inventor: Zachary A. YEUNG, Mission Viejo, CA (US)

(21) Appl. No.: 17/079,731

(22) Filed: Oct. 26, 2020

(51) Int. Cl. G06Q 30/02; G06Q 10/08; G06Q 10/10; G06Q 10/06; G06N 20/00; G06F 16/903; G06F 3/12

(52) U.S. Cl. CPC G06Q 30/0206; G06Q 30/0201; G06Q 10/087; G06Q 10/10; G06F 3/1256; G06N 20/00; G06F 16/90335; G06F 3/1208; G06F 3/125; G06Q 10/0637

(57) ABSTRACT

A system and method for determining which existing inventory on a retail premises is at risk for remaining unsold. Machine learning is applied to existing inventory product data, historical sales information and competitor pricing information obtained from online sources. Application of machine learning generates a list of suggested, revised prices for at risk items. Each revised price accepted by an administrator automatically generates an updated price label for the at risk items.

### TECHNICAL FIELD

This application relates generally to automated generation of product repricing to accelerate sale of slow moving goods or goods nearing an expiration date.

### BACKGROUND

While mail order purchases are on the rise, many products are still purchased by consumers at retail premises. This is especially the case for perishable items, such as groceries. A problem for retailers is attributed to products that remain unsold due to their prices being unreasonable or unacceptable for customers. A retailer may be unaware which products are not moving as expected. In such situations, excess inventory for certain products may exist, requiring excess shelf space or storage space. Also, certain goods have expiration dates which may cause them to be discarded before they are purchased.

### BRIEF DESCRIPTION OF THE DRAWINGS

Various embodiments will become better understood with regard to the following description, appended claims and accompanying drawings wherein:

FIG. 1 is an example embodiment of a system to identify and reprice goods for retail product loss minimization;

FIG. 2 is a flow diagram of a system to identify and reprice goods for retail product loss minimization;

FIG. 3 is an example embodiment of a digital device system;

FIG. 4 is a flowchart of an example embodiment of a system to identify and reprice goods for retail product loss minimization;

FIG. 5 is a hardware block diagram of an example embodiment of a system to identify and reprice goods for retail product loss minimization; and

FIG. 6 is a software block diagram of an example embodiment of a system to identify and reprice goods for retail product loss minimization leveraging cloud based services.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In example embodiments disclosed herein, a system and method provides for assisting retailers who may not know about issues with unsold products. Products may sit in inventory until it's too late to sell them, attributable to factors such as spoilage, product expiration, product obsolesce or seasonal nature. Problems may also be attributed to higher pricing relative to the same or similar goods at a retail location or at another location operated by a competitor. It is difficult for employees to review a vast range of products in a retail location to determine if a product is not meeting a targeted or anticipated sales goal. Products that sit on a shelf until expiry, or selling it off to overstock vendors, creates revenue loss and wastes resources.

Example embodiments herein provide for automatically determining which products are at risk of not selling in accordance with an in-house inventory list. The system applies machine learning to determine which products have a high-probability of not selling. The system then generates new, competing prices for identified, risky products that will promote sales. The system generates new prices by looking at historical sales of the product at the current retail location, suitably using an on-premises database, as well as performing a comparison with pricing information available online. Once new pricing is generated, the system alerts retail administration personnel to consider changing product pricing to mitigate revenue loss. An administrator can then choose to accept the price change where the system generates a new price tag and sends it to a label printer for printing or to update pricing on a wireless, electronic pricing tag displayed by corresponding products.

In the example embodiments, the system saves employee time by providing more rapid and accurate pricing for slow selling items, rather than relying on human calculation which can be error prone and time consuming. Example embodiments conserve resources by preventing products from being unsold and, ultimately disposed.

Example embodiments include an on-premises system that can be controlled by the management personnel of a given retail location that sells a wide variety of products. The system does a comparison of items in stock periodically, such as daily, monthly or seasonally, to identify items that are at risk of not being sold at a reasonable pace. The system takes these products' current prices, and compares prices with historical data, such as data from the current retail location, as well as online data to formulate a new price for the item. Personnel can then choose to accept or decline the price change. If they accept it, the system generates a new label and sends it to a label printer or an electronic price tag where it can then be displayed on a sales floor along with associated goods.

Example embodiments herein use machine learning to formulate more competitive pricing for items that are not selling as projected. This system saves time for a management team by automatically generating new prices without employees having to spend time on research and calculations. Moreover, the system mitigates risk of revenue lost and facilitates resource conservation by substituting a lower price on items in order to get products out the door rather than disposing the products or shipping them off to third-party, discount vendors.

Example embodiments provide for automatic generation of prices for products that are selling slowly or becoming overstocked. Historically, retailers might manually make a decision based on their interpretation of product data they've collected over time. This is error prone. It may be difficult or impossible to run “what-if” situations. Even when management personnel at a retail location do develop a new price for a product, they have to manually make price tags based on manual input.

Example embodiments herein save time by leveraging machine learning technology to generate a competitive price for products on the floor that are selling slowly or becoming overstocked. Machine learning allows for more variables and insight to be accommodated in the calculation of new prices. Additionally, the system automatically detects items that are in stock and selling slowly, suitably based off of information stored locally. The system suitably makes the prices even more competitive by referencing a secure program, suitably cloud based, that looks up prices for similar products online and find the typical price for the products. This allows the retail location to know if they are publishing a price too high for a customer's liking.

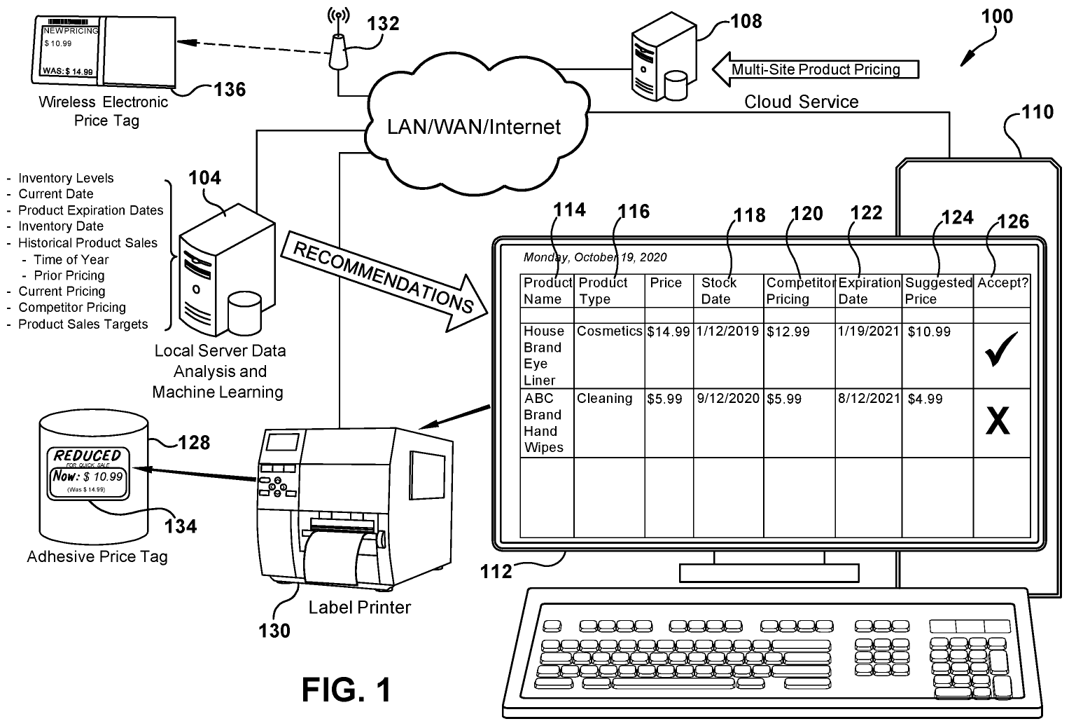

FIG. 1 illustrates an example embodiment of a system 100 to identify and reprice goods for retail product loss minimization. A server 104 is suitably associated with or located on a retail premises and stores inventory data corresponding to existing store inventory on the premises. Inventory data suitably comprises data relative to current inventory levels including levels of identified products, current date, product expiration dates, historical product sale information, current pricing, competitor pricing and product sales targets. Information such as competitor pricing is suitably gleaned by a direct search of competitor web information. Such information may also be obtained by a third party information aggregator, such as cloud service. Competitor product information suitably includes, for one or more identified product, average pricing or a range of pricing. Server 104 applies machine learning to inventory data and competitor pricing data to determine a suggested, optimized price for each product determined to be risky, that is, at risk of remaining unsold, ultimately being removed from inventory, sold off or disposed of. Recommended pricing information is provided to store personnel via an electronic device such as a workstation, smartphone, tablet computer, or the like. In the illustrated example, information is provided via display 112 of workstation 110. Displayed information suitably includes product name 114, product type 116, stock date 118, competitor pricing information 120, expiration date 122, and a suggested product price 124. An acceptance prompt 126 allows a user to selectively accept or reject suggested pricing as indicated. For each accepted price, price label information is sent to label printer 130 for printing of price label 134, suitably applied to merchandise 128. Alternatively, price label information is suitably communicated wirelessly via access point 132 to wireless tags, such as wireless electronic tag 136.

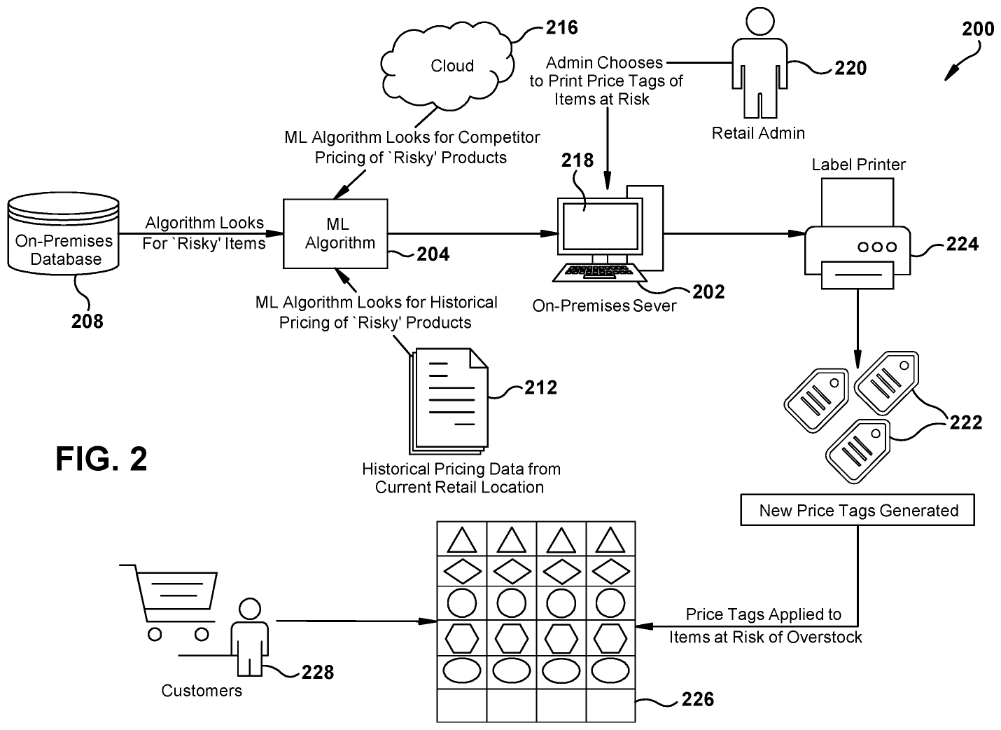

FIG. 2 is a flow diagram of an example embodiment of a system 200 to identify and reprice goods for retail product loss minimization. On premises server 202 facilitates machine learning system 204, which system is fed information from on database 208, as well as historical pricing data 212 from the current retail location. Competitor pricing information is also input, suitably via cloud service 216. Machine learning is suitably applied to available information via server 202. Any suitable machine learning platform may be used, such as TensorFlow, Google Cloud ML Engine, Accord.net, Shogun, or the like.

Alternative pricing information for products identified as risky is displayed on a user interface display 218, and retail administrator 220 decides whether to accept new pricing suggestion for each identified product. Each accepted pricing label 222 is printed automatically via label printer 224 and affixed to stock items 226. Customers, such as customer 228, suitably select and purchase items at the modified price, moving product that may otherwise remain unsold.

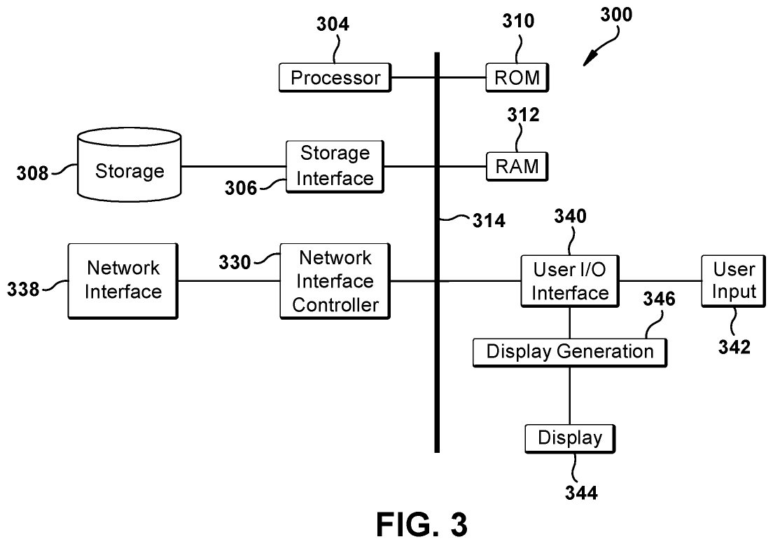

Turning now to FIG. 3, illustrated is an example of a digital device system 300 suitably comprising server 104 of FIG. 1 and server 202 of FIG. 2. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wired or wireless data connection via network interface 338. A suitable data connection to a label printer or server is via a data network, such as a local area network (LAN), a wide area network (WAN), which may comprise the Internet, or any suitable combination thereof. A digital data connection is also suitably made with a label printer or server, such as via BLUETOOTH, optical data transfer, Wi-Fi direct, or the like.

Processor 304 is also in data communication with a user input/output (I/O) interface 340 which provides data communication with user peripherals, such as user input 342, such as a keyboard, trackball, touchscreen mice, or the like, and screen display 344 via display generator 346. It will be understood that functional units are suitably comprised of intelligent units, including any suitable hardware or software platform.

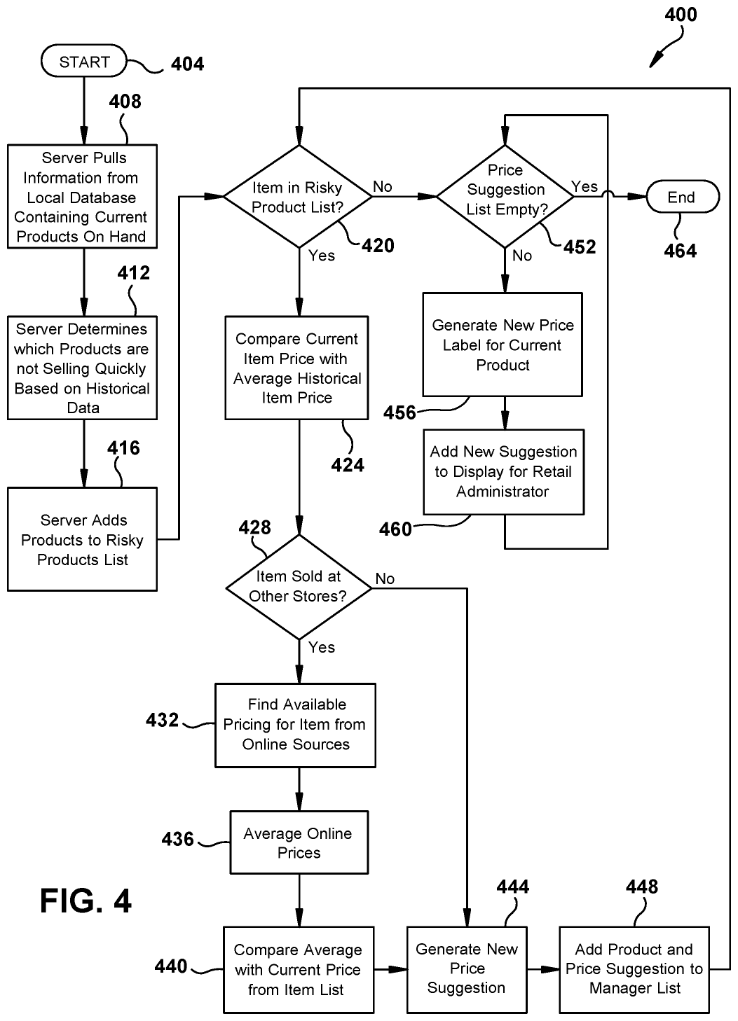

FIG. 4 is a flowchart 400 of an example embodiment of a system to identify and reprice goods for retail product loss minimization. The process commences at block 404 and proceeds to block 408 where a server pulls information from a local database containing information on current products on hand. Next, at block 412, the server determines which products are not selling quickly based on historical data. The server then adds identified products to a risky products list at block 416. Next, items in the list are polled, commencing at block 420. When an item is determined to be in the risky product list at block 420, a comparison of a current item price is made with an average historical price at block 424, and a determination is made at block 428 as to whether the item is sold in other stores. If so, available pricing from other sources is obtained at block 432 and averaged at block 436. A comparison with the current product price and the averaged online pricing is made at block 440, leading to generation of a new price suggestion at block 444. If a determination is made at block 420 that information on the item is not available from other sources, the system proceeds directly to block 444.

When a new price suggestion is generated at block 444, it is added to product and price suggestions on a manager list at block 448, and the system returns to block 420 to determine other list items remain. When a determination is made that no further risky products remain in block 420, the system proceeds to block 452 where a check is made as to whether any suggested pricing changes exist. If so, a new price label is generated at block 456, and added to a manager selection display at block 460. Once no more pricing suggestions exist at block 452, the process ends at block 464. At this point, an administrator has a complete list of inventory products determined to be risky, along with suggested price modifications. The administrator picks which items should have revised pricing, and corresponding labels are generated automatically for selected items.

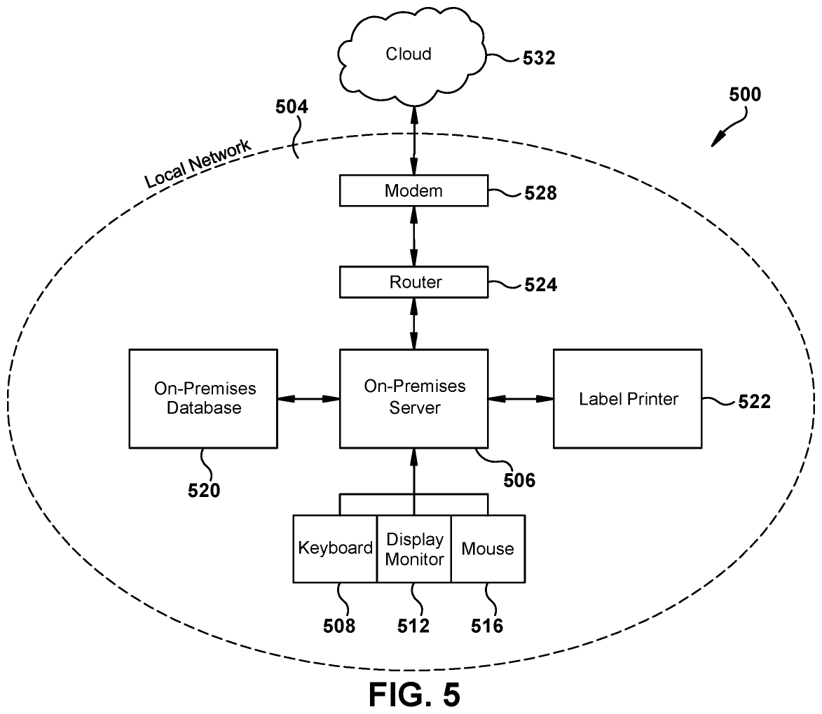

FIG. 5 is a hardware block diagram of an example embodiment of a system 500 to identify and reprice goods for retail product loss minimization. A local network 504 includes an on-premises server 506, which includes a user interface comprised of keyboard 508, display monitor 512 and mouse 516. Server 506 includes on on-premises database 520, suitably comprised of the same server or as a separate database server. Server 506 is in data communication with label printer 522, as well as router 524. Router 524 is in data communication with a network interface, illustrated as modem 528 which provides a gateway from local network 504 to cloud 532, suitably including a cloud service or virtual machine.

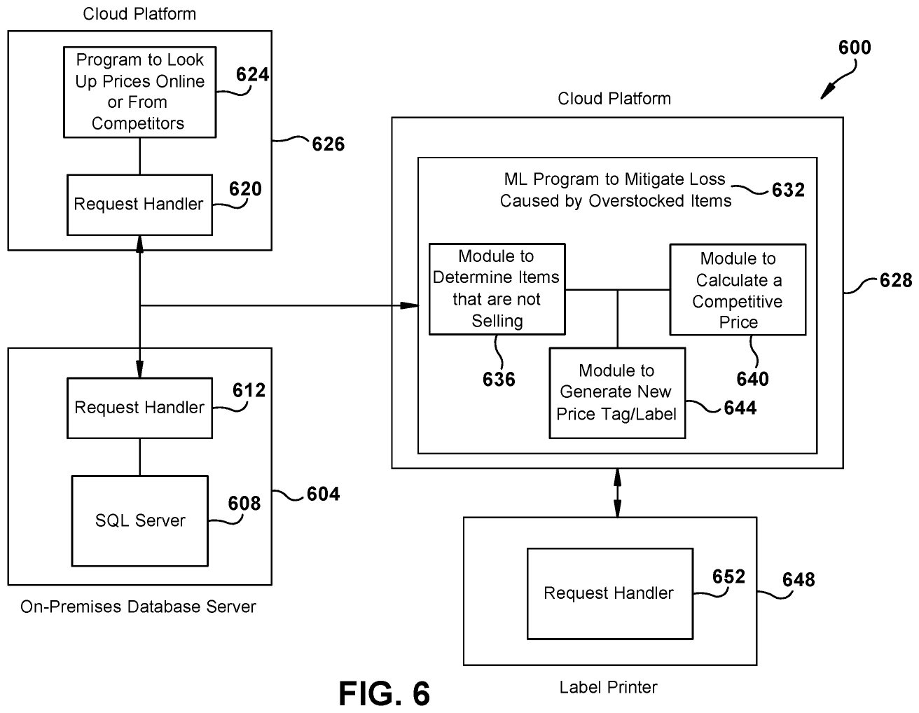

FIG. 6 is a software block diagram of an example embodiment of a system 600 to identify and reprice goods for retail product loss minimization leveraging cloud based services. Included is an on-premises database server 604, suitably one using structured query language (SQL) server 608 and a request handler 612. Third party information is obtained via cloud platform 626, comprised of a program 624 to look up online competitor pricing, working in conjunction with request handler 620.

Cloud platform 628 is comprised of machine learning system 632 to mitigate product loss caused by overstock, a module 636 that determines items that are not selling, a module 640 to calculate competitive pricing and a module 644 to generate new price tags or labels. Label printer 648 prints labels received via request handler 652.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a network interface configured to receive competitor pricing data corresponding to competitor pricing for each of the plurality of products; and
a processor and associated memory, the memory storing inventory data corresponding to existing inventory for sale from a retail sales premises, wherein the inventory data includes, for each of a plurality of products, data corresponding to current pricing, current inventory level, time of year and duration of time in inventory,
the processor configured to identify risky products in accordance with the inventory data and the competitor pricing data, the risky products comprising products determined to be at risk of being sold at a suitable pace, including products at risk of being sold off,
the processor further configured to generate modified pricing data for each identified risky product in accordance with the inventory data and the competitor pricing data, and
the processor further configured to generate pricing labels corresponding to modified pricing data by one or more of
automatically printing one or more labels bearing indicia of modified pricing specified by the modified pricing data, and
wirelessly communicating the modified pricing label to one or more wireless electronic price tags to show indicia of the modified pricing specified by the modified pricing data on an associated electronic price tag display.

2. The system of claim 1 further comprising:
a user interface including a user input and a display,
wherein the processor is further configured to generate a user query relative to user acceptability of generated modified pricing, and
wherein the processor is configured to initiate the generation of pricing labels for each modified pricing when accepted by the user responsive to a generated query.

3. The system of claim 2 wherein, after each of a series of specified intervals, the processor is further configured to:
retrieve updated inventory data,
receive updated competitor pricing data corresponding to competitor pricing for each of the plurality of products,
identify current risky products in accordance with the updated inventory data and updated competitor pricing,
generate new modified pricing suggestions for each identified risky product in accordance with the updated inventory data and the updated competitor pricing data,
generate a new query relative to user acceptability of new generated modified pricing suggestions, and
initiate generation of new pricing labels for each user accepted new modified pricing suggestion via a label printer.

4. The system of claim 2 wherein the processor is further configured to send modified pricing corresponding to each user accepted modified pricing suggestion to an electronic label display positioned proximately to corresponding goods.

5. The system of claim 1 wherein the inventory data includes data corresponding to expiration dates associated with the products.

6. The system of claim 1 wherein the inventory data includes goal data corresponding to targeted sale levels for the products.

7. The system of claim 1 wherein the inventory data includes historical sales information for prior sales of each of the plurality of products at the retail sales premises.

8. The system of claim 1 further comprising a label printer configured to print tangible pricing labels from modified pricing received from the processor.

9. A method comprising:
storing, in a memory, inventory data corresponding to existing inventory for sale from a retail sales premises, wherein the inventory data includes, for each of a plurality of products, data corresponding to current pricing, current inventory level, time of year and duration of time in inventory,
receiving competitor pricing data corresponding to competitor pricing for each of the plurality of products via a network interface;
identifying, via a processor, risky products in accordance with the inventory data and the competitor pricing data, the risky products comprising products determined to be at risk of being sold at a reasonable pace, including products at risk of being sold off;
generating, via the processor, modified pricing data for each identified risky product in accordance with the inventory data and the competitor pricing data;
initiating, via the processor, generation of pricing labels corresponding to modified pricing data; and
automatically printing one ore more labels bearing indicia of modified pricing specified by the modified pricing data or wirelessly communicating the modified pricing label to one or more wireless electronic price tags to show indicia of the modified pricing specified by the modified pricing data on an associated electronic price tag display.

10. The system of claim 9 further comprising:
generating, on a display, a user query relative to acceptability of generated modified pricing, and
wherein generation of pricing labels for each modified pricing is initiated only when accepted by the user responsive to a generated query.

11. The method of claim 10 wherein, after each of a series of specified intervals:
retrieving updated inventory data;
receiving updated competitor pricing data corresponding to competitor pricing for each of the plurality of products;
identifying current risky products in accordance with the updated inventory data and updated competitor pricing data;
generating new modified pricing suggestions for each identified risky product in accordance with the updated inventory data and the updated competitor pricing data;
generating a new query relative to user acceptability of new generated modified pricing suggestions; and
outputting new pricing labels for each user accepted new modified pricing suggestion via a label printer.

12. The method of claim 10 further comprising sending modified pricing corresponding to each accepted modified pricing suggestion to an electronic label display positioned proximately to corresponding goods.

13. The method of claim 9 wherein the inventory data includes data corresponding to expiration dates associated with the products.

14. The method of claim 9 wherein the inventory data includes goal data corresponding to targeted sale levels for the products.

15. The method of claim 9 wherein the inventory data includes historical sales information for prior sales of each of the plurality of products at the retail premises.

16. The method of claim 9 further comprising printing tangible pricing labels from modified pricing labels received from the processor.

17. A system comprising:
memory storing inventory for product stocked at a retail premises, the inventory data including a product identifier for each of a plurality of products, quantity of each identified product, a sales rate for each identified product, a pricing set for each identified product, and a targeted sales rate for each identified product,
the memory further storing historical sales data corresponding to historical sales of each identified product at the premises;
a network interface configured to receiving competitor data, the competitor data including data corresponding to sales of each identified product by a different retail premises; and
a processor configured to identify risky products in accordance with the inventory data, the historical sales data and the competitor pricing data,
the processor further configured to generate modified pricing for each identified risky product in accordance with the inventory data, the historical sales data and the competitor pricing data, and
the processor further configured to generate pricing labels corresponding to modified pricing on a label printer or via wireless connection to electronic price tags associated with goods displayed on the premises.

18. The system of claim 17 wherein, after each of a series of specified intervals, the processor
is further configured to:
retrieve updated inventory data,
receive updated competitor pricing data corresponding to competitor pricing for each of the plurality of products,
identify current risky products in accordance with the updated inventory data and updated competitor pricing data,
apply machine learning to the inventory data and the updated inventory data for each identified risky product,
generate new modified pricing suggestions for each identified risky product in accordance with applied machine learning,
generate a new query relative to user acceptability of new modified pricing suggestions on a user interface display, and
generate new pricing labels for each user accepted new modified pricing suggestion.

19. The system of claim 18 wherein the network interface is further configured to receive the competitor pricing data from an associated cloud service, the competitor pricing data comprising typical pricing from a plurality of third party sources.

20. The system of claim 19 wherein the historical sales date includes a rate of sale for each identified product on the premises.
